(19) United States
(12) Patent Application Publication
(10) Pub. No.: US 2008/0164781 A1
(43) Pub. Date: Jul. 10, 2008

(54) Rotating Electric Machine

(75) Inventor: Masaki Taguchi, Gunma (JP)

Correspondence Address: OLIFF & BERRIDGE, PLC, P.O. BOX 320850, ALEXANDRIA, VA, 22320-4850, US

(73) Assignee: MITSUBA CORPORATION, GUNMA (JP)

(21) Appl. No.: 11/886,501

(22) PCT Filed: Apr. 17, 2006
(86) PCT No.: PCT/JP2006/308026

§ 371 Date: Oct. 19, 2007

(30) Foreign Application Priority Data
Apr. 19, 2005 (JP) 2005-120989

(51) Int. Cl. H02K 9/28; H02K 13/00

(52) U.S. Cl. 310/227; 310/245

(57) ABSTRACT

A rotating electric machine includes an end bracket; a commutator; a brush holder stay with a first end surface and a second end surface, wherein the first end surface is covered by the end bracket; a brush holder provided at the second end surface of the brush holder stay; a brush that is equipped in the brush holder and slidably contacts with the commutator; and a heat transfer medium for transferring heat of the brush is provided between the end bracket and the brush holder stay.

### CROSS-REFERENCE TO RELATED APPLICATIONS

This application is the U.S. National Stage of PCT/JP2006/308026, filed Apr. 17, 2006, which claims priority from JP2005-120989, filed Apr. 19, 2005, the entire disclosures of which are incorporated herein by reference hereto.

### BACKGROUND

The present invention relates to a rotary electric machine.

There exists an electric motor as an example of a rotary electric machine. The electric motor is constructed such that a front end portion of a brush slidably contacts in an elastically urged manner with a outer circumferential surface of a commutator provided on a motor shaft. The brush of such an electric motor tends to have a high temperature. As this tendency becomes more prominent, the weight and size of the electric motor are further reduced. Conventionally, a structure has been proposed in order to cope with heat generated inside an electric motor. The structure that has been employed for cooling down the interior of the electric motor uses a fan provided on the motor shaft so that air within the electric motor circulates in and out of the electric motor (see Japanese Published Unexamined Patent Application No. 2001-61257, for example). Accordingly, the brush is cooled.

### SUMMARY

In the conventional art described above, however, not only does the number of necessary components to be used increases as a fan is additionally required, but the length of the motor shaft also must be longer as the motor is mounted thereon. The size of the electric motor to be used will thus be larger. The present invention solves the above problem as well as other problems and is also able to achieve other advantages.

The disclosure addresses an exemplary aspect, in which a rotary electric machine includes an end bracket; a commutator; a brush holder stay with a first end surface and a second end surface, wherein the first end surface is covered by the end bracket; a brush holder provided at the second end surface of the brush holder stay; a brush that is equipped in the brush holder and slidably contacts with the commutator; and a heat transfer medium for transferring heat of the brush is provided between the end bracket and the brush holder stay

In another exemplary aspect, the heat transfer medium is formed at a position corresponding to the brush.

In another exemplary aspect, the heat transfer medium is a convex portion that is provided on at least one of the end bracket and the brush holder stay.

In another exemplary aspect, the heat transfer medium couples the end bracket and the brush holder stay together.

In another exemplary aspect, an air channel is formed between the end bracket and the brush holder stay in order to communicate with air outside of the rotary electric machine, and the heat transfer medium is formed in the space.

In another exemplary aspect, the end bracket is metallic.

In another exemplary aspect, the brush holder stay is formed of an insulating resin material.

According to various exemplary aspects of the disclosure, heat generated by the brush is efficiently released outside the electric motor not only without increasing the size of the electric motor but also without increasing the number of components.

According to various exemplary aspects of the disclosure, abnormal heat generation from the brush is efficiently avoided.

According to various exemplary aspects of the disclosure, heat from the brush is released outside the electric motor by a simple configuration.

According to various exemplary aspects of the disclosure, because a heat transfer from the end bracket to the brush holder stay side is efficiently carried out, heat of the brush is efficiently released outside the electric motor.

According to various exemplary aspects of the disclosure, because the heat transfer medium is cooled by means of air blowing against the heat transfer medium, abnormal heat generation from the brush is prevented.

According to various exemplary aspects of the disclosure, heat that is generated in the rotary electric machine is efficiently released outside.

According to various exemplary aspects of the disclosure, heat that is generated by slidable contact of the brush is efficiently transferred to the end bracket side with the brush holder stay, which is also a circuit board.

### BRIEF DESCRIPTION OF THE DRAWINGS

Various embodiments of the invention will be described with reference to the drawings, wherein:

FIG. 1 is a partially sectional side view of an electric motor;

FIG. 2 is an enlarged sectional view of the main part of an electric motor;

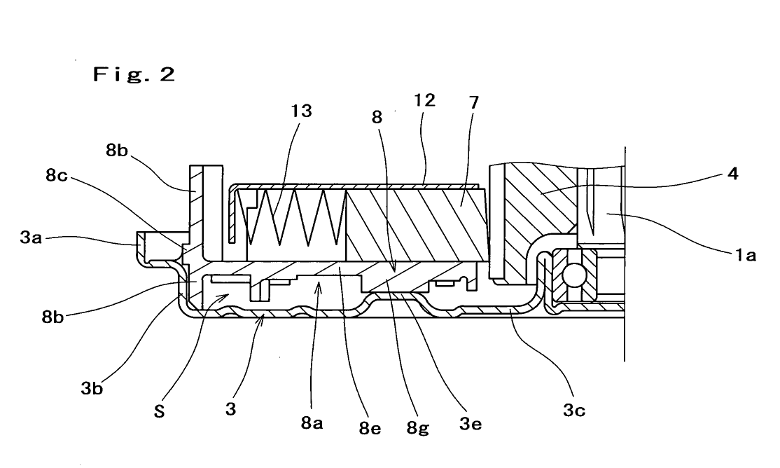

FIG. 3A is a front view of a brush holder stay, FIG. 3B is a rear view of a brush holder stay, and FIG. 3C is a sectional view along X-X in FIG. 3A;

FIG. 4A is a front view of an end bracket, FIG. 4B is a rear view of an end bracket, and FIG. 4C is a sectional view along X-X in FIG. 4A;

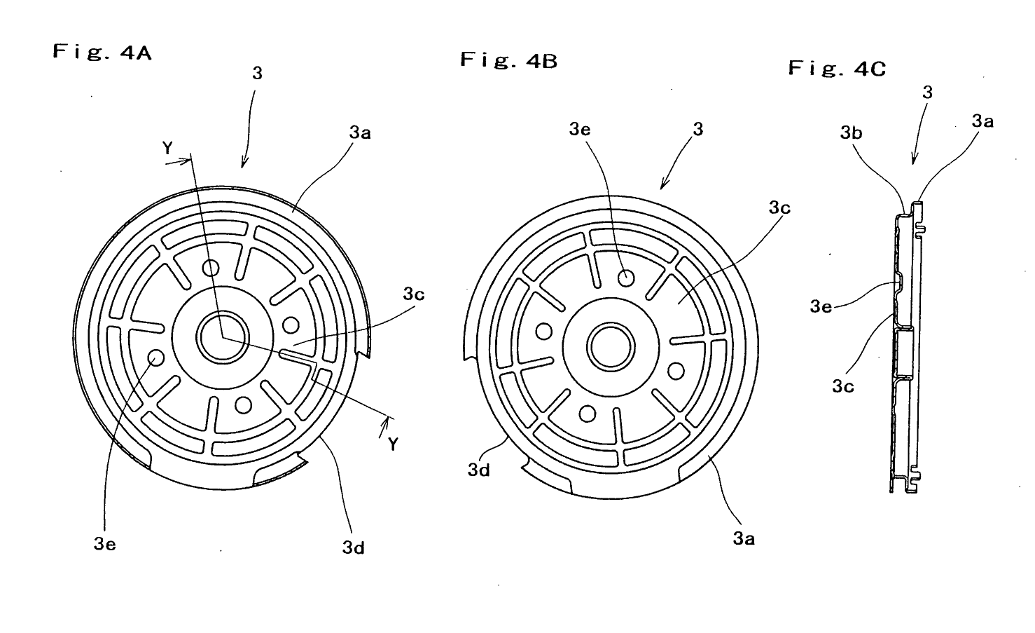

FIG. 5A is a front view of an electric motor, FIG. 5B is a rear view of an electric motor, and FIG. 5C is a front view of a yoke; and

FIGS. 6A, 6B, 6C, and 6D are a second, third, fourth, and fifth embodiment of a heat transfer medium, respectively.

### DETAILED DESCRIPTION OF EMBODIMENTS

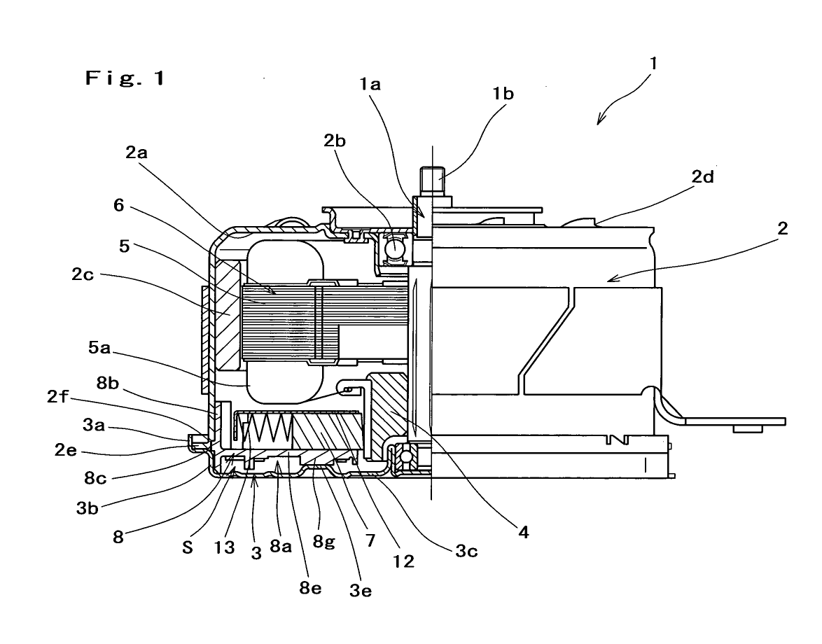

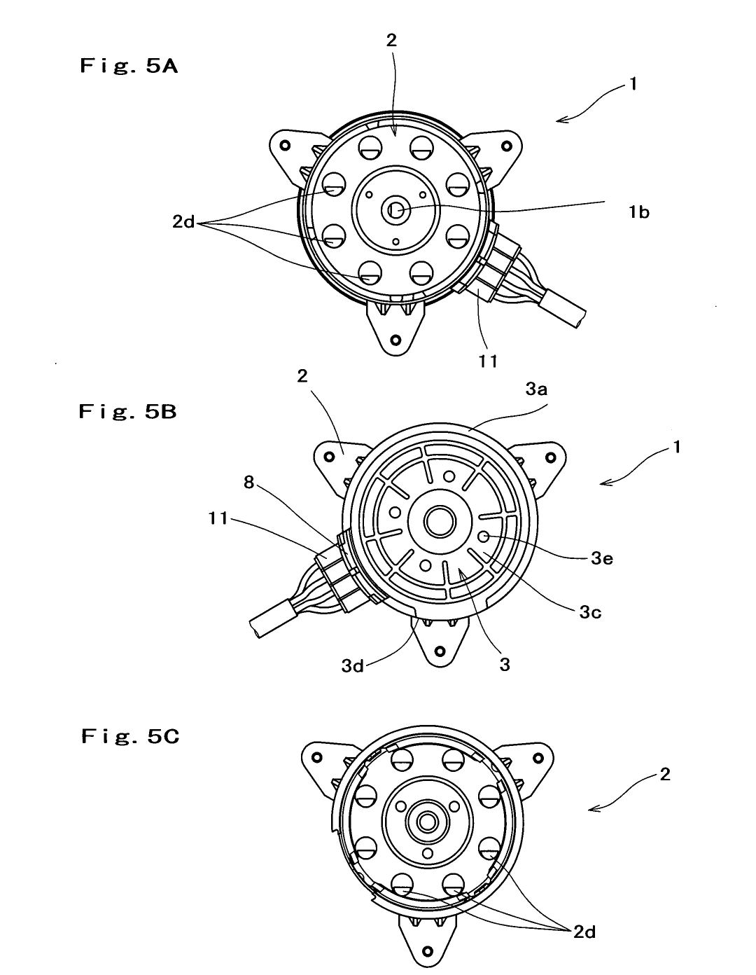

Next, various embodiments of the present invention will be described based on the drawings. In FIG. 1, and FIGS. 5A and 5B, reference numeral 1 denotes an electric motor (a rotating electric machine) that functions as a fan motor. A motor shaft 1a of the electric motor 1 is supported so as to be freely rotatable via a bearing 2b on a bottom portion 2a of a yoke 2 that has a cylindrical shape with a bottom whose one end is opened. The motor shaft 1a is also set so that a fan (not shown) is provided on a front end portion 1b that protrudes outward from the yoke bottom portion 2a. Another end portion of the motor shaft 1a is supported so as to be freely rotatable via a bearing 3a on a metallic end bracket 3 that covers the opening end of the yoke 2. On the motor shaft 1a, provided so as to be integrally rotatable, are a commutator 4 that is located on the end bracket 3 side and an iron core 5 that is located closer to the yoke bottom portion 2a side than to the commutator 4 (see FIG. 1).

A rotor 6 is constructed by winding a coil 5a around the iron core 5 (see FIG. 1). The commutator 4 to which an end portion of the coil 5a is electrically connected is structured so that a brush 7 slidably contacts therewith, which is described later. The rotor 6 rotates as external power is supplied to the commutator 4 and coil 5a via the brush 7. Reference numeral 2c denotes a permanent magnet that is fixed to the inner circumferential surface of the yoke 2.

The metallic end bracket 3 is formed into a shallow cylindrical shape with a bottom. A flange portion 2e that is formed at the end of the yoke 2 is abutted in a surface contact state against a flange portion 3b that is formed at an opening end of the end bracket 3.

A brush holder stay 8 that supports the brush 7 is integrally formed from a stay body portion 8a that is made from an insulating resin material and is formed like a disk, and from an extending portion 8b that is extended outward from an outer rim of the stay body portion 8a to both sides of the shaft core direction of the motor shaft 1a.

A yoke 2 side half of the extending portion 8b is internally fitted to the inner circumferential surface of the yoke 2 in a surface contact state. The sidehalf of the extending portion 8b that is opposite the end bracket 3 is internally fitted to the inner circumferential surface of the end bracket 3 in a surface contact state, and an extended front end thereof abuts against a cylinder bottom surface of the end bracket 3. As a result, a space S is formed between the stay body portion 8a of the brush holder stay 8 that is tabular and faces an end bracket bottom surface 3c and the end bracket bottom surface 3c. On the outer circumferential surface of the extending portion 8b, formed is a projecting portion 8c that is inserted and latched with a step portion 2f that is formed on an inner corner surface of the opening end of the yoke 2.

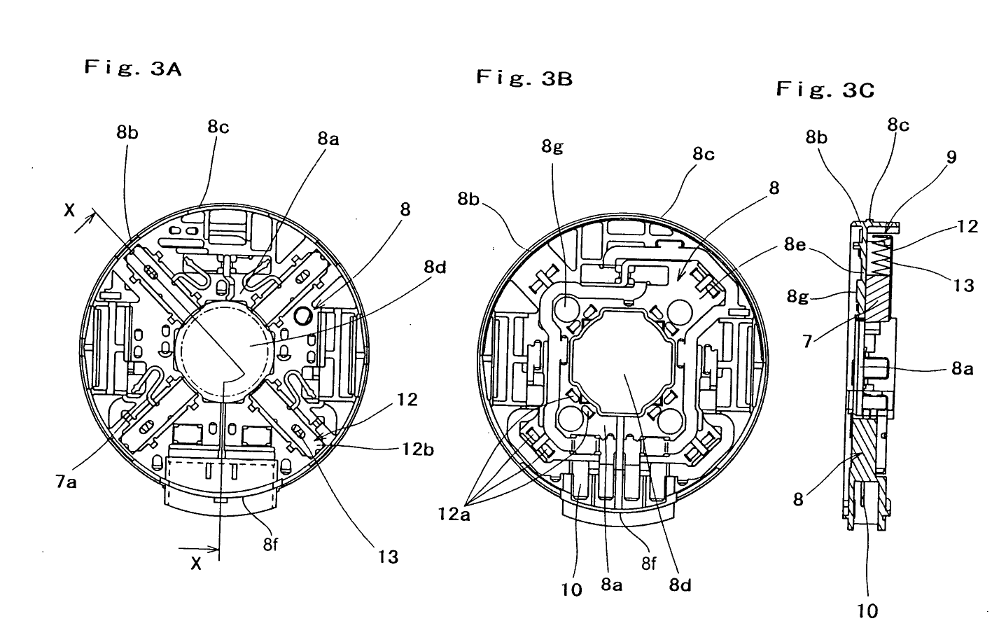

A through-hole 8d through which the motor shaft 1a passes is opened at a center portion of the stay body portion 8a (see FIGS. 3A and 3B). On a plate surface that faces the cylinder bottom side of the yoke 2, respectively provided are brush holders 9 at four points in the circumferential direction with a positional relationship radiated with reference to a hole center of the through-hole 8d (see FIG. 3C). In these respective brush holders 9, respectively housed are brushes 7 so as to be freely raised and set. Pig tails 7a drawn out of the respective brushes 7 are electrically connected to respective terminal plates 10 that are incorporated in the brush holder stay 8, and an external extracting coupler 11 is connected to these respective terminal plates 10. External power is fed to the brushes 7 as an external coupler (not shown) connects to the external extracting coupler 11.

Reference numeral 12 denotes a holder bracket of the brush holder 9 (see FIG. 3C). For the holder bracket 12, a metallic plate material bent in a laid U-shape is fixed in a manner of caulking to the stay body portion 8a via latching claws 12a, whereby a cylindrical brush holder 9 is constructed, and the outside diameter-side end of the brush holder 9 is blocked by bending a plate strip 12b of the holder bracket 12.

The brush holder 9 is composed of the holder bracket 12 and a holder portion 8e of the stay body portion 8a surrounded by the holder bracket 12. In the respective brush holders 9 composed as such, respectively housed are the brushes 7 so as to be freely raised and set. And these brushes 7 are set so that the inside diameter-side ends slidably contact in an elastically urging manner with the outer circumferential surface of the commutator 4 by springs 13 interposed between the outside diameter ends of the respective brush holders 9 and the plate strips 12b.

Furthermore, on the flange portion 3b of the end bracket 3 and the extending portion 8b of the brush holder stay 8, formed are vent holes 3d and 8f that communicate with the space S that is formed between the end bracket 3 and brush holder stay 8. A vent hole 2d is also formed on the bottom surface of the yoke 2, whereby a ventilation channel passing through the space S is formed in the motor.

On the holder portion 8e of the brush holder stay 8, formed in a protruded condition, located at a position corresponding to the brush 7, is a convex portion 8g facing toward the bottom surface 3c side of the end bracket 3. Meanwhile, formed on the bottom surface 3c of the end bracket 3 is a convex portion 3e opposing the holder stay side convex portion 8g, and front end portions of these convex portions 8g and 3e are constructed so as to abut against each other and to compose a heat transfer medium of the present invention. As a result, the heat transfer medium is provided in the space S serving as the ventilation channel.

In the present embodiment constructed as described above, the rotor 6 is driven to rotate as a result of power feed to the brush 7. Although the brush 7 generates some heat as a result of slidably contacting in an elastically urging manner with the commutator 4, the generated heat is actively transferred to the end bracket 3 side through the convex portions 8g and 3e, as a heat transfer medium, that are formed on the brush holder stay 8 and end bracket 3. Accordingly the heat generation from the brush 7 is suppressed; thus, abnormal heat generation by the brush 7 is suppressed.

In other words, when the abnormal heat generation from the brush 7 is suppressed as described above, it is not necessary to use a cooling fan as is often the case with the conventional art in order to suppress abnormal heat generation. Therefore, simplification of the structure and a reduction in the number of components to be used is realized.

Moreover, since the convex portions 8g and 3e abut against each other, heat transfer is more reliable and an efficient heat transfer is performed. And since the convex portions 8g and 3e are provided at corresponding positions of the brush 7 that can be a heat generating source, a further efficiency of heat transfer is actualized.

Furthermore, since the convex portions 8g and 3e are formed between the end bracket 3 and brush holder stay 8 and formed in the space S that serves as an air channel, the convex portions 8g and 3e are also cooled by air that flows through the space, and thus an outstanding cooling effect of the brush 7 is achieved.

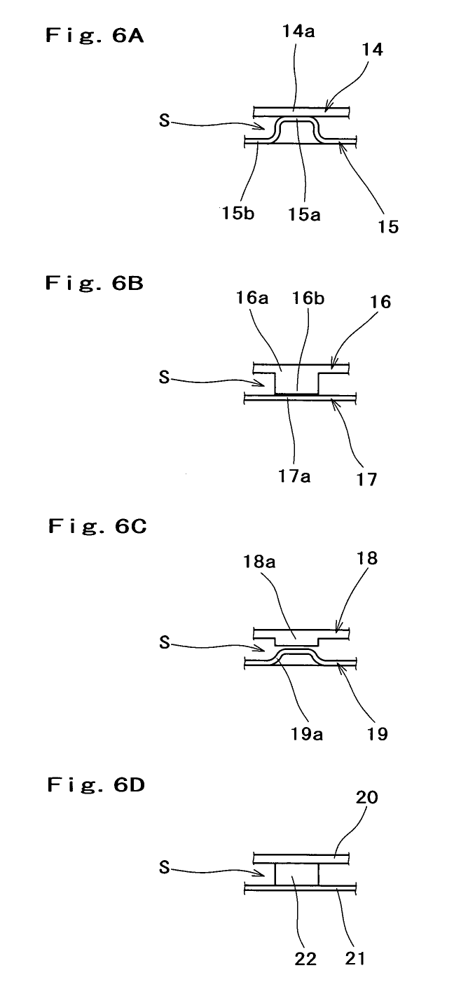

In the present embodiment, the heat transfer medium is composed of the convex portions 8g and 3e respectively formed on the brush holder stay 8 and the end bracket 3. Composition of heat transfer medium, however, is not limited thereto. As a second embodiment shown in FIG. 6A, it is possible that a holder portion 14a of a brush holder stay 14 is planate, a convex portion 15a that abuts against the holder portion 14a is formed on a bottom surface 15b of an end bracket 15, and a heat transfer medium is composed.

Furthermore, as a third embodiment, a heat transfer medium can also be constructed, as shown in FIG. 6B, by providing a convex portion 16b that abuts against a plane-shaped bottom surface 17a of an end bracket 17 on a holder portion 16a of the brush holder stay 16.

Meanwhile, in the first embodiment, the end bracket 3 is composed of a metal in order to have a higher heat conductivity than the brush holder stay that is formed of a resin material has so that a better heat transfer medium is formed. An end bracket made of a resin may be used, however.

In the first embodiment, the heat transfer medium couples the brush holder stay 8 and the end bracket 3 together, but, the heat transfer medium is not restrictive thereto. As a fourth embodiment shown in FIG. 6C, a convex portion 18a that is formed on a brush holder stay 18 and a convex portion 19a that is formed on an end bracket 19 are arranged so that a heat transfer can be performed via a slight, but adequate space (approximately 1 mm or less, for instance) between the front end portions thereof opposing each other.

Furthermore, as a fifth embodiment shown in FIG. 6D, with a separate member 22 interposed as a heat transfer medium between a brush holder stay 20 and an end bracket 21, the present invention can be performed.

The present invention is useful for a rotating electric machine such as an electric motor that is a component of electric equipment to be mounted on a vehicle or the like. Because the present invention does not require a fan to cool heat generated inside the electric motor, heat generated by the brush is efficiently released outside the electric motor without increasing the number of components. Abnormal heat generation by the brush is also avoided.

1. A rotating electric machine, comprising:
an end bracket;
a commutator;
a brush holder stay with a first end surface and a second end surface, wherein the first end surface is covered by the end bracket;
a brush holder provided at the second end surface of the brush holder stay;
a brush that is equipped in the brush holder and slidably contacts with the commutator; and,
a heat transfer medium for transferring heat of the brush is provided between the end bracket and the brush holder stay.

2. The rotary electric machine according to claim 1, wherein the heat transfer medium is formed at a position corresponding to the brush.

3. The rotary electric machine according to claim 1, wherein the heat transfer medium is a convex portion provided on at least one of the end bracket and the brush holder stay.

4. The rotary electric machine according to claim 1, wherein the heat transfer medium couples the end bracket and the brush holder stay together.

5. The rotary electric machine according to claim 1, wherein as an air channel is formed between the end bracket and the brush holder stay in order to communicate with air outside of the rotary electric machine, and the heat transfer medium is formed in the space.

6. The rotary electric machine according to claim 1, wherein the end bracket is metallic.

7. The rotary electric machine according to claim 1, wherein the brush holder stay is formed of an insulating resin material.

8. The rotary electric machine according to claim 1, wherein the heat transfer medium is a convex portion provided on the end bracket and a convex portion provided on the brush holder stay.

9. The rotary electric machine according to claim 8, wherein the convex portion provided on the end bracket abuts against the convex portion provided on the brush holder stay.

10. The rotary electric machine according to claim 8, wherein there is a space between the convex portion provided on the end bracket and the convex portion provided on the brush holder stay.

11. The rotary electric machine according to claim 1, wherein the heat transfer member is a separate member provided between the end bracket and the brush holder stay.

12. A rotating electric machine comprising:
an end bracket;
a brush holder stay; and
a heat transfer medium for transferring heat is provided between the end bracket and the brush holder stay.

13. The rotary electric machine according to claim 12, wherein the heat transfer medium is a convex portion provided on at least one of the end bracket and the brush holder stay.

14. The rotary electric machine according to claim 12, wherein the heat transfer medium couples the end bracket and the brush holder stay together.

15. The rotary electric machine according to claim 12, wherein an air channel is formed between the end bracket and the brush holder stay in order to communicate with air outside of the rotary electric machine, and the heat transfer medium is formed in the space.

16. The rotary electric machine according to claim 12, wherein the end bracket is metallic.

17. The rotary electric machine according to claim 12, wherein the brush holder stay is formed of an insulating resin material.

18. The rotary electric machine according to claim 12, wherein the heat transfer medium is a convex portion provided on the end bracket and a convex portion provided on the brush holder stay.

19. The rotary electric machine according to claim 18, wherein the convex portion provided on the end bracket abuts against the convex portion provided on the brush holder stay.

20. The rotary electric machine according to claim 18, wherein there is a space between the convex portion provided on the end bracket and the convex portion provided on the brush holder stay.

21. The rotary electric machine according to claim 12, wherein the heat transfer member is a separate member provided between the end bracket and the brush holder stay.
